(19) United States
(12) Patent Application Publication
(10) Pub. No.: US 2015/0317740 A1
(43) Pub. Date: Nov. 5, 2015

(54) COMPUTER-IMPLEMENTED METHOD FOR ESTIMATING INSURANCE RISK OF A STRUCTURE BASED ON TREE PROXIMITY

(71) Applicant: Buildfax (a d/b/a of BUILDERadius, Inc.), Asheville, NC (US)

(72) Inventors: Joseph Tierney Masters Emison, Asheville, NC (US); Richard W. White, Trumbull, CT (US)

(21) Appl. No.: 14/265,816

(22) Filed: Apr. 30, 2014

(51) Int. Cl. G06Q 40/08

(52) U.S. Cl. CPC G06Q 40/08

(57) ABSTRACT

Computer-implemented methods of estimating insurance risk of one or more structures are described. The computer-implemented methods may be based on a combination of tree characteristic information and insurance loss data that are used together to calculate a Tree Proximity Score for the one or more structures through a computer processor. The tree characteristic information may include vegetation density data, tree height, tree geometric characteristics, and tree species information, and may be based on tree sensor data which may include satellite imagery, aerial imagery, or LiDAR. The insurance loss data may include wind loss data such as a wind loss frequency, severity, or ratio. The high level of correlation between the Tree Proximity Score and insurance loss data is shown in an example. The Tree Proximity Score may be used in the insurance industry in insurance policy implementation and underwriting.

### BACKGROUND OF THE INVENTION

1. Field of the Invention

The present disclosure relates to computer-implemented methods of estimating insurance risk of one or more structures based on a combination of tree characteristic information and insurance loss data that are used together to calculate a Tree Proximity Score for the one or more structures through a computer processor.

2. Description of Related Art

The cost of replacing a roof due to wind, hail, or other weather damage can be significant and depends on the type of materials being replaced. For example, the cost to professionally remove and replace asphalt shingles, the most common type of roofing material, can exceed $8,000 for a typical ranch style home. The cost to replace more expensive materials such as metal, tile, or slate can reach into the tens of thousands of dollars. Further, roof damage is present in 85-95% of wind-related insured property losses each year, according to the Insurance Institute for Business & Home Safety (IBHS), and loses from thunderstorms cost insurers $14.9 billion in 2012, according to the Insurance Information Institute. Damage from nearby trees that are blown over and fall on the roof of a structure is a major contributor to wind-related roof damage claims.

As a typical homeowners insurance annual premium is only a fraction of the cost of a roof replacement, replacing a roof can be an expensive proposition for insurance companies. Although damage from wind, rain, and hail are typically covered by insurance policies, many insurance companies are taking steps to mitigate their losses. In addition, there has been an attempt to address these types of issues in the patent literature (See US 20130110558, incorporated by reference herein in its entirety). However, there still remains a need for insurance companies to have tools that allow them to address the risk of losses due to roof and other weather damage in their business practices.

### SUMMARY OF THE INVENTION

The present inventor has developed a Tree Proximity Score that correlates highly with the frequency and extent of losses due to wind damage for structures or properties. The Tree Proximity Score may be determined based on a combination of tree characteristic information such as vegetation density values surrounding each of a plurality of structures and insurance loss data such as wind loss data for the structures. The tree characteristic information may be determined based on tree sensor data which may include satellite imagery, aerial imagery, or light detection and ranging (LiDAR). The tree characteristic information may be determined for an area with a radius surrounding a set of geospatial coordinates corresponding to the address or geographic location of one or more structures. The Tree Proximity Score may be used by insurance agents or adjusters to evaluate the risk of wind loss of a structure and take appropriate steps to mitigate the risk. Accordingly, embodiments of the present disclosure provide a computer-implemented method for estimating the risk of wind loss of a target structure or a plurality of structures based on the Tree Proximity Score. The methods of the present disclosure are implemented using a computer processor.

One embodiment of the present disclosure is a computer-implemented method of estimating the insurance risk for wind damage for a plurality of structures comprising applying insurance loss data to tree characteristic information to calculate a Tree Proximity Score using a computer processor. In this embodiment, the tree characteristic information is confined to a geographic area with a radius from each set of a plurality of sets of geospatial coordinates, the Tree Proximity Score is calculated for each of the sets of geospatial coordinates, and the geospatial coordinates correspond to the geographic locations of a plurality of structures.

Another embodiment of the present disclosure is a computer-implemented method of estimating the insurance risk for wind damage for a target structure, the method comprising receiving a query comprising an address of a target structure, converting the address of the target structure to a set of geospatial coordinates, and returning the Tree Proximity Score for the set of geospatial coordinates that corresponds to the address of the target structure. In this embodiment, the Tree Proximity Score is returned from an electronic database of Tree Proximity Scores calculated according to the present disclosure.

Another embodiment of the present disclosure is a computer-implemented method of estimating the insurance risk for wind damage for a target structure, the method comprising receiving a query comprising a set of geospatial coordinates corresponding to the address of a target structure and returning the Tree Proximity Score for the set of geospatial coordinates corresponding to the address of the target structure. In this embodiment, the Tree Proximity Score is returned from an electronic database of Tree Proximity Scores calculated according to the present disclosure.

Another embodiment of the present disclosure is a computer-implemented method of estimating the insurance risk for wind damage for a target structure, the method comprising receiving a query comprising an address of a target structure, converting the address of the target structure to a set of geospatial coordinates, calculating, according to the present disclosure, the Tree Proximity Score for the set of geospatial coordinates corresponding to the address of the target structure, and optionally returning the Tree Proximity Score for the set of geospatial coordinates corresponding to the address of the target structure.

Another embodiment of the present disclosure is a computer-implemented method of estimating the insurance risk for wind damage for a target structure, the method comprising receiving a query comprising a set of geospatial coordinates corresponding to the geographic location of a target structure, calculating, according to the present disclosure, the Tree Proximity Score for the set of geospatial coordinates corresponding to the geographic location of the target structure and optionally returning the Tree Proximity Score for the set of geospatial coordinates corresponding to the address of the target structure.

Another embodiment of the present disclosure is a computer-implemented method of estimating the insurance risk for wind damage for a target structure, the method comprising receiving a query for an address of a target structure or a set of geospatial coordinates corresponding to the geographic location of a target structure; optionally, converting the address of the target structure to a set of geospatial coordinates corresponding to the geographic location of a target structure if an address is received; and calculating a Tree Proximity Score for the set of geospatial coordinates. In this embodiment, the Tree Proximity Score is calculated for a geographic area defined by a radius from the set of geospatial coordinates, and the Tree Proximity Score calculation is determined by applying insurance loss data to vegetation density values corresponding to a radius of each set of a plurality of sets of geospatial coordinates corresponding to geographic locations of a plurality of structures wherein the insurance loss data is applied such that it scales or curves the vegetation density values, determines the radius for each set of the plurality of sets of geospatial coordinates, or determines curving or scaling of the vegetation density values according to geographic area.

In any embodiment of this disclosure, the insurance loss data may be wind loss data and the Tree Proximity Score may positively correlate with wind loss data.

In any embodiment of this disclosure, the correlation between Tree Proximity Score and wind loss data has a correlation coefficient that may be positive, including an R² value of 0.01 to 1.00, and preferably an R² value from 0.30 to 1.00, and more preferably an R² value from 0.70 to 1.00, including 0.70, 0.75, 0.80, 0.85, 0.90, 0.95, or higher.

In any embodiment of this disclosure, the tree characteristic information may be a vegetation density value corresponding to an area within the radius of each set of geospatial coordinates.

In any embodiment of this disclosure, the insurance loss data may be applied such that it scales or curves the vegetation density values.

In any embodiment of this disclosure, the insurance loss data may be applied such that it determines the radius for each set of geospatial coordinates.

In any embodiment of this disclosure, the insurance loss data may be applied such that it determines curving or scaling of the vegetation density values according to geographic area.

In any embodiment of this disclosure, the insurance loss data may be applied such that it determines the radius of each set of geospatial coordinates according to geographic area.

In any embodiment of this disclosure, the wind loss data may be wind loss frequency, or wind loss severity, or wind loss ratio, or any combination of these.

In any embodiment of this disclosure, the set of geographic coordinates may be a latitude and longitude.

In any embodiment of this disclosure, the geographic area may be any one or more selected from the group consisting of address, tax parcel polygon, street, neighborhood or development, subdivision, zip5, city, county, zip3, Metropolitan Statistical Area (MSA), and state.

In any embodiment of this disclosure, the vegetation density value may be the Normalized Difference Vegetation Index (NDVI).

In any embodiment of this disclosure, the vegetation density value may be selected from any one or more of the group consisting of the Perpendicular Vegetation Index, the Soil-Adjusted Vegetation Index, the Atmospherically Resistant Vegetation Index, the Global Environment Monitoring Index, and the Fraction of Absorbed Photosynthetically Active Radiation.

In any embodiment of this disclosure, the tree characteristic information may be selected from any one or more of the group consisting of tree geometric dimensions, tree height, and a tree species classification.

In any embodiment of this disclosure, the tree characteristic information may be a combination of two or more of a vegetation density value, tree geometric dimensions, tree height, and a tree species classification.

In any embodiment, the tree characteristic information may be combined with other layers such as Land Use/Land Cover, Digital Elevation Models (DEM), Soils, etc. In another exemplary embodiment, data from Land Use/Land Cover indexes may be applied to the NDVI to calculate the Tree Proximity Score.

In any embodiment of this disclosure, the tree characteristic information may be derived from any one or more raw tree sensor data selected from the group consisting of satellite imagery, aerial imagery, and LiDAR.

In any embodiment of this disclosure, the set of geospatial coordinates corresponds to a single point.

In any embodiment of this disclosure, the set of geospatial coordinates corresponds to a plurality of points representing a polygon and the tree characteristic information within a radius of the edges of the polygon is used to calculate the Tree Proximity Score.

### BRIEF DESCRIPTION OF THE DRAWINGS

The accompanying drawings illustrate certain aspects of embodiments of the present invention, and should not be used to limit or define the invention. Together with the written description the drawings serve to explain certain principles of the invention.

FIG. 1 is a schematic diagram showing an embodiment of a computer-implemented method according to this disclosure.

FIG. 2 is a schematic diagram showing an embodiment of a computer system according to this disclosure.

FIG. 3A is a graph showing exemplary relationships between the Tree Proximity Score and Wind Loss Frequency and between the Tree Proximity Score and Wind Loss Ratio according to an embodiment of this disclosure.

FIG. 3B is a table showing exemplary values of the Tree Proximity Score (values represent middle of range), Wind Loss Frequency, and Wind Loss Ratio and exemplary correlation coefficients between Tree Proximity Score and Wind Loss Frequency and Tree Proximity Score and Wind Loss Ratio according to an embodiment of this disclosure.

FIG. 4A is a United States Department of Agriculture's National Agriculture Imagery Program (NAIP) infrared image for a residential and commercial area according to an embodiment of this disclosure.

FIG. 4B is an NAIP Normalized Difference Vegetation Index (NDVI) image for a residential and commercial area according to an embodiment of this disclosure.

FIG. 4C is an image representing an overview of the residential and commercial area of FIGS. 4A and 4B.

FIG. 4D is an image of the residential and commercial area of FIGS. 4A and 4B showing tree identification according to an embodiment of the methods of this disclosure, wherein dark shading represents taller trees.

FIG. 5A is an NAIP infrared image for a rural area according to an embodiment of this disclosure.

FIG. 5B is an NAIP NDVI image for a rural area according to an embodiment of this disclosure.

FIG. 5C is an image representing an overview of the rural area of FIGS. 5A and 5B.

FIG. 5D is an image of the rural area of FIGS. 5A and 5B showing tree identification according to an embodiment of the methods of this disclosure, wherein dark shading represents taller trees.

FIG. 6A is an NAIP infrared image for a suburban area near a water body according to an embodiment of this disclosure.

FIG. 6B is an NAIP NDVI image for a suburban area near a water body according to an embodiment of this disclosure.

FIG. 6C is an image representing an overview of the suburban area near a water body of FIGS. 6A and 6B.

FIG. 6D is an image of the suburban area near a water body of FIGS. 6A and 6B showing tree identification according to an embodiment of the methods of this disclosure, wherein dark shading represents taller trees.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

As used herein, “structure” or “property” refers to any building with a roof and the two terms may be used interchangeably. The building may be for example a residential building such as a single family home or multiple family or occupant building (e.g. apartment building, townhouse, dormitory), a commercial building such as an office building, an academic building, or a government building.

As used herein, the terms “approximately”, “about”, or “around” applied to a value refer to a value that ranges from minus 10% of the value to plus 10% of the value. Thus, “approximately”, “about”, or “around” 100 would refer to any number from 90 to 110.

Tree Proximity Score Calculation

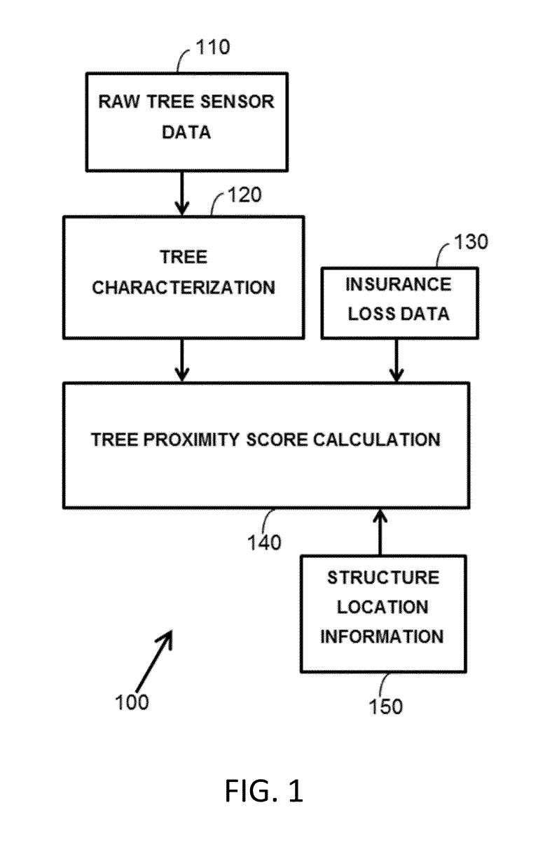

A tree proximity score can be calculated for a target property by determining whether and the extent to which large vegetation (e.g., tall trees) is present within a certain radius of a structure. The score can for example range from 0 to 100 and correspond respectively to scores representing a desert or infrastructure or bare earth to grasses and/or shrubs, to clusters of trees or forests surrounding the structure. In one embodiment, as shown in FIG. 1, the computer-implemented method 100 of the present disclosure uses raw tree sensor data 110 to characterize trees with respect to one or more features 120 and combines these characteristics 120 with insurance loss data 130 and structure geographic location information 150 to calculate a Tree Proximity Score 140 using a computer processor. As used herein, “raw tree sensor data” 110 may be any data obtained from any sensor that is configured to record electromagnetic energy that is reflected, scattered, diffracted, refracted, or dispersed as a result of striking any part of a tree such as the leaves or needles. The electromagnetic energy may be visible light or invisible portions of the electromagnetic spectrum such as any infrared or ultraviolet wavelength. The raw data 110 may be obtained from satellite or aerial imagery such as photographs or video of a geographic area. The satellite imagery may be from any meteorological satellite designed to image trees and other vegetation, which would include satellites housing radiometers such as those used for the United States Department of Agriculture's National Agriculture Imagery Program (NAIP), or the Advanced Very High Resolution Radiometer (AVHRR) and associated platforms. Meteorological satellites equipped with the AVHRR include the NOAA series of satellites including the Television Infrared Observation Satellite (TIROS) series. The following table provides the channel and wavelengths for the AVHRR/3 instrument. Channels 1 and 2, which represent visible and near-infrared wavelengths, respectfully, are particularly useful for monitoring vegetation.

| Channel | Wavelength |
|---|---|
| Number | (um) |
| 1 | 0.58-0.68 |
| 2 | 0.725-1.00 |
| 3A | 1.58-1.64 |
| 3B | 3.55-3.93 |
| 4 | 10.30-11.30 |
| 5 | 11.50-12.50 |

However, in other embodiments, aerial video or photographs of vegetation from aircraft are used in substitution of the satellite imagery. The aerial photographs or video may be obtained from piloted aircraft or unmanned aircraft such as blimps or balloons, or Unmanned Aerial Vehicles (UAVs) including High Altitude Long Endurance (HALE) air vehicles. Some embodiments may be limited to satellite imagery, some embodiments may be limited to aerial imagery, and some embodiments may incorporate both satellite and aerial imagery. The imagery may be from any source, as long as it represents a multispectral or hyperspectral image which preferably includes both red and near-infrared spectral bands.

Further, in other embodiments, the raw data may be obtained from aerial measurements from instruments such as LiDAR instruments stationed on piloted or unmanned aircraft may be used alternatively or in addition to the aerial or satellite imagery data. The satellite imagery, aerial imagery, and/or LiDAR data may be obtained using any suitable infrared, visible, or ultraviolet wavelength or range of wavelengths. Further, the satellite imagery, aerial imagery, and/or LiDAR data may be obtained from various national, regional, or state governmental databases, from private databases, from academic databases, or may be obtained directly from satellites or aircraft.

After obtaining the raw tree sensor data 110, the present method uses the raw data to determine 120 one or more tree characteristics. In one embodiment, the tree characteristics are based on vegetation density values that may be calculated from the satellite or aerial imagery. In an exemplary embodiment, the Normalized Difference Vegetation Index (NDVI) is used. The NVDI is calculated as:

$$N D V I = \frac{( NIR - VIS )}{( NIR + VIS )}$$

where VIS and NIR stand for the spectral reflectance measurements acquired in the visible (red) and near-infrared regions, respectively. However, alternatives to the NDVI may be used, including the Perpendicular Vegetation Index (See Richardson A. J. and C. L. Wiegand, 1977, ‘Distinguishing vegetation from soil background information’, Photogrammetric Engineering and Remote Sensing, 43, 1541-1552), the Soil-Adjusted Vegetation Index (See Huete, A. R., 1988, ‘A soil-adjusted vegetation index (SAVI)’, Remote Sensing of Environment, 25, 53-70), the Atmospherically Resistant Vegetation Index (See Kaufman, Y. J. and D. Tanre, 1992, ‘Atmospherically resistant vegetation index (ARVI) for EOS-MODIS’, in ‘Proc. IEEE Int. Geosci. and Remote Sensing Symp. '92, IEEE, New York, 261-270) the Global Environment Monitoring Index (See Pinty, B. and M. M. Verstraete (1992) ‘GEMI: A non-linear index to monitor global vegetation from satellites’, Vegetation, 101, 15-20), or the Fraction of Absorbed Photosynthetically Active Radiation or FAPAR.

In another exemplary embodiment, data from Land Use/Land Cover indexes may be applied to the NDVI to calculate the Tree Proximity Score. Land Use/Land Cover indexes are available from state government agencies and state universities. As described further below, the Land Use/Land Cover indexes may be used to determine categorical ranges for NDVI in a given area.

In other exemplary embodiments, the tree characteristics that are determined 120 may be tree geometric dimensions, tree height, tree canopy, and/or a tree species classification resulting from LiDAR data. The tree species classification may be determined with the use of a classification algorithm such as hierarchical clustering, k-means clustering, linear discriminant analysis, logistic regression, support vector machines, k-nearest neighbor, decision trees, neural networks, Bayesian networks, and Hidden Markov models. In some embodiments, only LiDAR data is used, however, in other embodiments no LiDAR data is used. The tree characteristics may be vegetation density data only, tree height only, tree dimensions only, tree species only, or may be any combination of two or more of these characteristics.

In exemplary embodiments, the tree characteristics 120 may be calculated for a given radius surrounding a structure or for a given radius surrounding an object such as a tree, including a radius of 5, 10, 15, 20, 25, 30, 40, 50, 60, 70, 80, 90, or 100 meters or more. In other exemplary embodiments, the tree characteristics may be calculated for a given geographic area, such as an address, tax parcel polygon, street, neighborhood or development, subdivision, zip5, city, county, zip3, Metropolitan Statistical Area (MSA), and state.

In embodiments, the insurance loss data 130 may be wind loss data such as wind loss claims, wind loss ratio, wind loss severity, or wind loss frequency, or any combination of these but may include any other type of insurance loss data as well including but not limited to hail, fire, lightning, flood, and earthquake. Typically, primary considerations for insurance carriers include loss frequency (what percentage of policies had a loss?) and loss severity (how much was the loss?). Secondarily, insurance carriers may be concerned with loss ratio (the amount paid out in loss, divided by the amount received in premium) and pure premium (the portion of the premium allocated to pay losses).

The structure location information may include publically available geographic mapping information such as Google Maps, Bing, Mapquest, or ESRI geographic systems software, which map the address of a structure to a specific geographic location or geospatial coordinates. In embodiments, the structure location information corresponds to the tree sensor data such that tree characteristics within a specified radius of a structure or structures may be calculated. For example, the structure location information in Google Maps may be mapped to satellite imaging data such that the tree sensor data and tree characterization information may be partitioned into specific areas within a radius surrounding a structure, geographic location, or geospatial coordinates of interest. In embodiments, the structure information may be mapped so that it may overlay the tree sensor information and/or tree characteristic information and vice versa.

In one embodiment, as shown in FIG. 1, the method 100 of the present disclosure applies the insurance loss data 130 to the tree characterization data 120 and combines this with the structure location information 150 to calculate a Tree Proximity Score 140 in the following way. In one exemplary embodiment, tree characteristics 120 are vegetation density values and the insurance loss data 130 is used to scale or curve the vegetation density values. For example, it may be found that all NDVI values less than a certain value such as 0.20 should be treated as having the same value, whereas NVDI values are more linear as they approach 1. However, the cutoff may be adjusted depending on factors such as geographic characteristics and the resolution of the satellite or aerial imagery. Further, the insurance loss data may be used to determine what the appropriate radius is around given geospatial coordinates to generate the score. The fact that there is a given geocoding error—both for properties and the satellite or aerial imagery—and also weather conditions and neighborhood realities, supports the method of treating vegetation values at a radius. Geocoding is the process of finding associated geographic coordinates from other geographic data. Street interpolation, parcel match, point of interest match, or GPS location are all examples of geocoding that can be used in embodiments of the invention.

For example, in some embodiments it has been found that a radius of around 10-15 meters performs the best. Further, the insurance loss data 130 may be used to make geo-specific scales/curves and radii. For example, within some zip codes, it may be best to use a radius of 10 meters, but for another, 15 meters may be optimal. However, other embodiments, based on zip code or other geographic location, may use a radius of about 5 meters to about 100 meters, including about 20 meters, about 25 meters, about 30 meters, about 40 meters, about 50 meters, about 60 meters, about 70 meters, about 80 meters, about 90 meters, or about 100 meters, or more. However, in other embodiments, the tree characterization data 120 includes values obtained from LiDAR such as tree height, tree geometry, tree diameter, and/or tree species, and the Tree Proximity Score is based on one or more of these characteristics or adjusted to factor in these characteristics.

The following is one example of a method of calculating the Tree Proximity Score. First, satellite imagery from NAIP is taken. NAIP imagery has a spatial resolution of up to 1 meter. Second, NDVI data is applied to it, and then Land Use/Land Cover indexes are used to determine categorical ranges for NDVI in a given area. In one embodiment, the categorical ranges can include, for example, −1 to 0.5 (indicating no tall trees), 0.5 to 0.72 (indicating likely tall trees), and 0.72 to 1 (indicating almost certainly tall trees). Third, multiple addresses and preferably every address in a particular geographical area in the insurance loss data is geocoded, and 20 sets of numbers are calculated, one set of numbers for each radius divisible by 5 from 5 m to 100 m, where each set counts the number of values in each categorical range within the radius. Fourth, for each radius, looking across all sets for all addresses, logistic regression analysis is used to come up with coefficients for each of the categorical range counts. (In this example, it is determined whether or not there was a wind loss as the independent variable). The R² values are also noted, and the radius with the highest R² values is selected. Lastly, the formula is calculated from the regression analysis for the top-scoring radius becomes the tree proximity score algorithm, scaled from 1 to 100 by multiplying the result by 100, using the ceiling function, and limiting the value range from 0 to 100.

In other embodiments, tree characterization information or data is directly obtained from a government, academic, or a private source that has calculated this from raw tree sensor data such that the step of obtaining raw tree sensor information is bypassed. For example, this information can be obtained directly by anyone for use in the systems and methods of the invention, including obtained by an insurance agent or an insurance adjuster, where appropriate. The tree characteristic information may be obtained from any government, private, or academic source. The tree characteristic information, tree sensor information, insurance loss information, and structure location information may be stored in an electronic database or a plurality of databases described herein. The information stored in the databases may be used by a processor to calculate a Tree Proximity Score according to a set of computer executable instructions (e.g. software). The Tree Proximity Score may also be stored in one or more electronic databases in memory after calculation. Further, the tree characteristic information may be stored in the electronic database as both a vector (polygon) representation or a raster (gridded cell) representation in order to calculate scores.

Modeling

In an exemplary embodiment, the present computer-implemented method 100 calculates (by way of a computer processor) a Tree Proximity Score 140 for a plurality of structures so that an area average Tree Proximity Score for different geographical areas (e.g., address, tax parcel polygon, street, neighborhood or development, subdivision, zip5, city, county, zip3, Metropolitan Statistical Area (MSA), and state) may be calculated. The area average Tree Proximity Score may be returned in situations where the aerial or satellite imagery is incomplete or unknown for a particular structure. For example, the area average Tree Proximity Score for a surrounding zip code may be returned if the target structure or property is within the zip code, aerial or satellite imagery is missing for the target structure or property, but enough aerial or satellite imagery is available for the surrounding zip code to calculate an area average Tree Proximity Score. If data is available, the area average Tree Proximity Score may also be returned for the neighborhood or street which contains the submitted address. In this way, the smallest area average that contains both the submitted address and for which the area average is available may be returned.

Computer-Executable Instructions

It will be understood that the various methods, processes, calculations and operations of the present invention described and/or depicted herein may be carried out by a group of computer-executable instructions that may be organized into routines, subroutines, procedures, objects, methods, functions, or any other organization of computer-executable instructions that is known or becomes known to a skilled artisan in light of this disclosure, where the computer-executable instructions are configured to direct a computer or other data processing device such as a processor to perform one or more of the specified processes and operations, such as determining one or more tree characteristics from tree sensor information and/or calculating a Tree Proximity Score. The computer-executable instructions may be written in any suitable programming language.

Computer-Readable Medium

Embodiments of the invention also include a computer readable medium comprising one or more computer files comprising a set of computer-executable instructions for performing one or more of the calculations, steps, processes and operations described and/or depicted herein. In exemplary embodiments, the files may be stored contiguously or non-contiguously on the computer-readable medium. Embodiments may include a computer program product comprising the computer files, either in the form of the computer-readable medium comprising the computer files and, optionally, made available to a consumer through packaging, or alternatively made available to a consumer through electronic distribution. As used in the context of this specification, a “computer-readable medium” includes any kind of computer memory such as floppy disks, conventional hard disks, CD-ROM, Flash ROM, non-volatile ROM, electrically erasable programmable read-only memory (EEPROM), and RAM. In exemplary embodiments, the computer readable medium has a set of instructions stored thereon which, when executed by a processor, cause the processor to determine one or more tree characteristics and/or a Tree Proximity Score based on data stored in the electronic database or memory described herein. The processor may implement this process through any of the procedures discussed in this disclosure or through any equivalent procedure.

In other embodiments of the invention, files comprising the set of computer-executable instructions may be stored in computer-readable memory on a single computer or distributed across multiple computers. A skilled artisan will further appreciate, in light of this disclosure, how the invention can be implemented, in addition to software, using hardware or firmware. As such, as used herein, the operations of the invention can be implemented in a system comprising any combination of software, hardware, or firmware.

Computers or Devices

Embodiments of this disclosure include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, operations, algorithms, statistical methods, formulas, or computational routines of this disclosure. The computer or device performing the specified calculations, processes, steps, operations, algorithms, statistical methods, formulas, or computational routines of this disclosure may comprise at least one processing element such as a central processing unit (i.e. processor) and a form of computer-readable memory which may include random-access memory (RAM) or read-only memory (ROM). The computer-executable instructions can be embedded in computer hardware or stored in the computer-readable memory such that the computer or device may be directed to perform one or more of the calculations, steps, processes and operations depicted and/or described herein.

Computer Systems

Additional embodiments of this disclosure comprise a computer system for carrying out the computer-implemented method of this disclosure. The computer system may comprise a processor for executing the computer-executable instructions, one or more electronic databases containing the data or information described herein, an input/output interface or user interface, and a set of instructions (e.g. software) for carrying out the method. The computer system can include a stand-alone computer, such as a desktop computer, a portable computer, such as a tablet, laptop, PDA, or smartphone, or a set of computers connected through a network including a client-server configuration and one or more database servers. The network may use any suitable network protocol, including IP, UDP, or ICMP, and may be any suitable wired or wireless network including any local area network, wide area network, Internet network, telecommunications network, Wi-Fi enabled network, or Bluetooth enabled network. In one embodiment, the computer system comprises a central computer connected to the internet that has the computer-executable instructions stored in memory that is operably connected to an internal electronic database. The central computer may perform the computer-implemented method based on input and commands received from remote computers through the internet. The central computer may effectively serve as a server and the remote computers may serve as client computers such that the server-client relationship is established, and the client computers issue queries or receive output from the server over a network. The queries may be an address of a target structure or geospatial coordinates of a target structure and may cause the server to calculate a Tree Proximity Score according to computer-executable instructions stored in memory where the Tree Proximity Score is calculated based on the address or geospatial coordinates or retrieve a Tree Proximity Score stored in memory that is associated with the address or geospatial coordinates. The client computers may execute queries to the server through any suitable network described herein. The queries may be executed in any suitable query language such as Structured Query Language (SQL), or a translator library for raster geospatial data formats may be used such as Geospatial Data Abstraction Library (GDAL).

The input/output interfaces may include a graphical user interface (GUI) which may be used in conjunction with the computer-executable code and electronic databases. For example, the graphical user interface may allow a user to input a property address or geospatial coordinates and display a Tree Proximity Score or other output of the computer-implemented method of this disclosure in a variety of report formats. The graphical user interface may allow a user to perform these tasks through the use of text fields, check boxes, pull-downs, command buttons, and the like. A skilled artisan will appreciate how such graphical features may be implemented for performing the tasks of this disclosure. The user interface may optionally be accessible through a computer connected to the internet. In one embodiment, the user interface is accessible by typing in an internet address through an industry standard web browser and logging into a web page. The user interface may then be operated through a remote computer (client computer) accessing the web page and transmitting queries or receiving output from a server through a network connection.

Such graphical controls and components are reusable class files that are delivered with a programming language. For example, pull-down menus may be implemented in an object-oriented programming language wherein the menu and its options can be defined with program code. Further, some programming languages integrated development environments (IDEs) provide for a menu designer, a graphical tool that allows programmers to develop their own menus and menu options. The menu designers provide a series of statements behind the scenes that a programmer could have created on their own. The menu options may then be associated with an event handler code that ties the option to specific functions. Text fields, check boxes, and command buttons may be implemented similarly through the use of code or graphical tools. A skilled artisan can appreciate that the design of such graphical controls and components is routine in the art.

In embodiments, the Tree Proximity Score may be used in a system of the disclosure in the following way. In some embodiments, Tree Proximity Scores corresponding to a plurality of structures are stored in an electronic database. The electronic database may be stored in a memory. A user of a client computer may query the electronic database through a network such as the internet connected to a server that may have access to the electronic database. The query may be an address of a target structure or geospatial coordinates corresponding to the target structure, or any other identifying information for a target structure. If the query is an address of a target structure, a processor may convert the address of the target structure to geospatial coordinates corresponding to the target structure. Upon submission of the query, the server may return the Tree Proximity Score corresponding to the geospatial coordinates of the target structure based on the stored value of the Tree Proximity Score for those geospatial coordinates in the electronic database.

In other embodiments, a user of a client computer may query an electronic database through a network such as the internet connected to a server that may have access to the electronic database. The electronic database may be stored in a memory and include tree characterization data, or tree sensor information that may be converted to tree characterization data through a processor. The electronic database may further include insurance loss information, such as wind loss data, or other types of insurance loss information. The electronic database may optionally include structure location information such as the geospatial locations and/or addresses of a plurality of structures. The memory may further include a set of computer-executable instructions for calculating a Tree Proximity Score according to this disclosure. The query may be an address of a target structure or geospatial coordinates corresponding to the target structure. If the query is an address of a target structure, a processor may convert the address of the target structure to geospatial coordinates corresponding to the target structure. Upon submission of the query to the server, the processor may calculate the Tree Proximity Score corresponding to the geospatial coordinates of the target structure according to the set of computer-executable instructions and the server may optionally return the Tree Proximity Score through the network to the client computer.

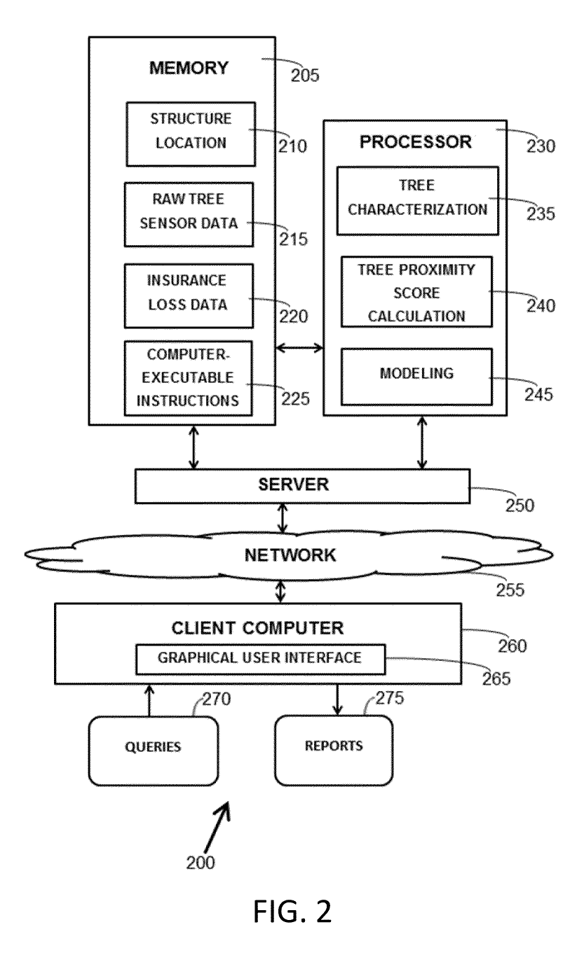

An exemplary embodiment of a computer system 200 according to this disclosure is shown in FIG. 2. The computer system 200 comprises a memory or storage 205. The memory or storage 205 comprises data and information, such as structure location information 210, raw tree sensor data 215, and insurance loss data 220. The data 210, 215, and 220 may be stored in electronic databases or other form of storage in memory 205. The memory 205 also includes a set of computer-executable instructions 225 for instructing a processor 230. The computer executable instructions 225 may instruct the processor 230 connected to the memory 205 to execute data processing functions according to the computer-executable instructions 225. The data processing functions may include tree characterization 235 based on the raw tree sensor data 215, calculation of a Tree Proximity Score 240 based on the tree characterization 235, structure location information 210, and insurance loss data 220, as well as modeling 245 of the Tree Proximity Score. A processor and memory may be connected to or may be components of a server 250 with a connection to a network 255, such as the internet. Queries and other inputs may be entered into a graphical user interface 265 such as a webpage displayed using an industry standard web browser on a client computer 260 connected to the network 355 and transmitted to the server 250 and an output or report 275 may be returned from the server 250 to the client computer 260 through the graphical user interface 265. The queries 270 may be an input of an address or geospatial coordinates of a structure or property and the output 275 may be a Tree Proximity Score corresponding to the address or geospatial coordinates or an average Tree Proximity Score for a plurality of structures. The Tree Proximity Score may be returned 275 in response to a query 270 based on a value stored in memory 205 or based on a value calculated directly by the processor 230.

### EXAMPLE 1

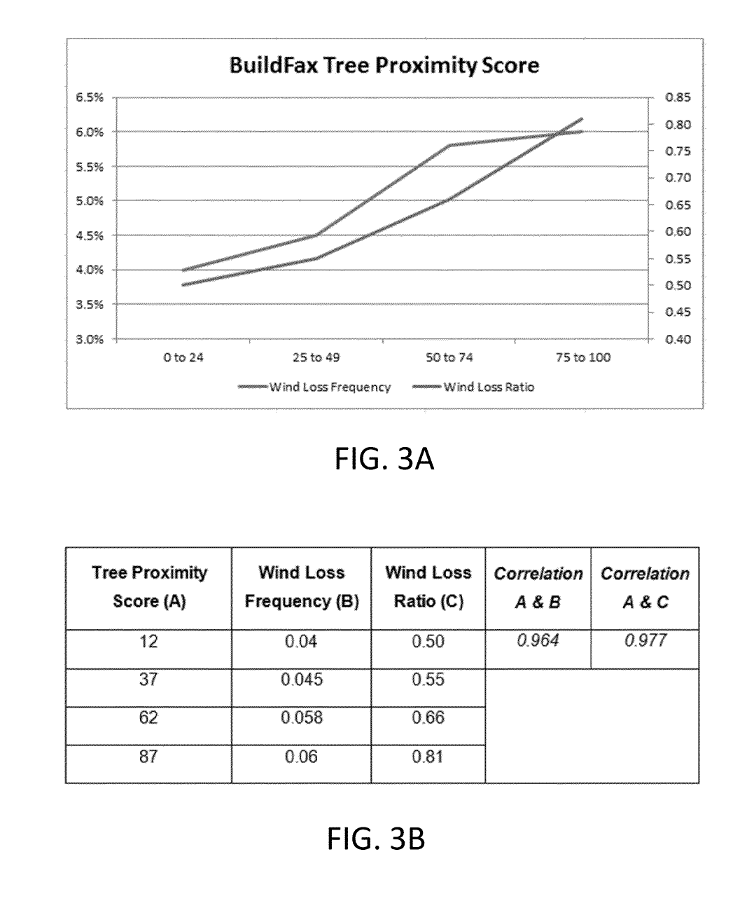

FIG. 3A is a graph showing the relationship between the Tree Proximity Score of the present disclosure and Wind Loss Frequency as well as Wind Loss Ratio and FIG. 3B is a table showing correlation coefficients between the Tree Proximity Score and Wind Loss Frequency and Tree Proximity Score and Wind Loss Ratio. As shown in the table of FIG. 3B, the correlation coefficient between Tree Proximity Score and Wind Loss Frequency was 0.964 and the correlation coefficient between Tree Proximity Score and Wind Loss Ratio was 0.977. However, other embodiments of the present disclosure may have correlation coefficients representing the relationship between the Tree Proximity Score and Wind Loss Frequency and Tree Proximity Score and Wind Loss Ratio of at least 0.50 up to 1.00, including at least 0.55, 0.60, 0.65, 0.70, 0.75, 0.80, 0.85, 0.90, 0.91, 0.92, 0.93, 0.94, 0.95, 0.96, 0.97, 0.98, and 0.99.

### EXAMPLE 2

An end user such as an insurance agent or adjuster uses a client computer to send an address over a network such as the internet to a server connected to or including a processor and memory of this disclosure. The processor then geocodes that address to a latitude and longitude, calculates a Tree Proximity Score for that latitude and longitude according to the computer executable instructions, satellite or aerial imagery for that latitude and longitude, and insurance data stored in the memory, and transmits the Tree Proximity Score through the server over the network to the client computer.

### EXAMPLE 3

An end user such as an insurance agent or adjuster uses a client computer to send geospatial coordinates (a point or a polygon) over a network such as the internet to a server connected to or including a processor and memory of this disclosure. The processor then calculates the Tree Proximity Score for those geospatial coordinates according to the computer executable instructions, satellite or aerial imagery for those geospatial coordinates, and insurance data stored in the memory, and transmits the Tree Proximity Score through the server over the network to the client computer. For polygons, the processor runs the radius from the edges of the polygon.

The above examples 2 and 3 could be performed on-demand to get a score in less than a second on an individual location, or in batch to get results on millions of properties within a day or two. The score may be calculated in direct response to the query or returned from a memory from a previously calculated value.

### EXAMPLE 4

In embodiments, Insurers may offer different products/prices based upon whether tall trees are next to structures (homes or businesses). An insurer can pre-populate that field based upon the Tree Proximity Score, such as a Score less than a certain value (e.g. 75) means No tall trees next to the structure and a Score greater or equal to that value means Yes there are tall trees located next to the target structure. The insured can then be allowed to provide evidence if the insured disagrees, such as current photos of the property showing tall trees have been removed. In other embodiments, Insurers may also offer different products/prices (rates) based upon the actual Tree Proximity Score. In addition, insurers may decide to inspect properties or not based upon the Tree Proximity Score. For example, insurers may decide that it's not worth inspecting properties with a Tree Proximity Score of less than a certain value (e.g. 80) whereas they want to inspect all properties with a score more than that value. This could save insurers a lot of money, because inspections are often quite expensive (usually 20% or more of one year's premium).

### EXAMPLE 5

Tree Proximity Scores could be useful in other models, like Automated Valuation Models (which estimate the market value of structures).

### EXAMPLE 6

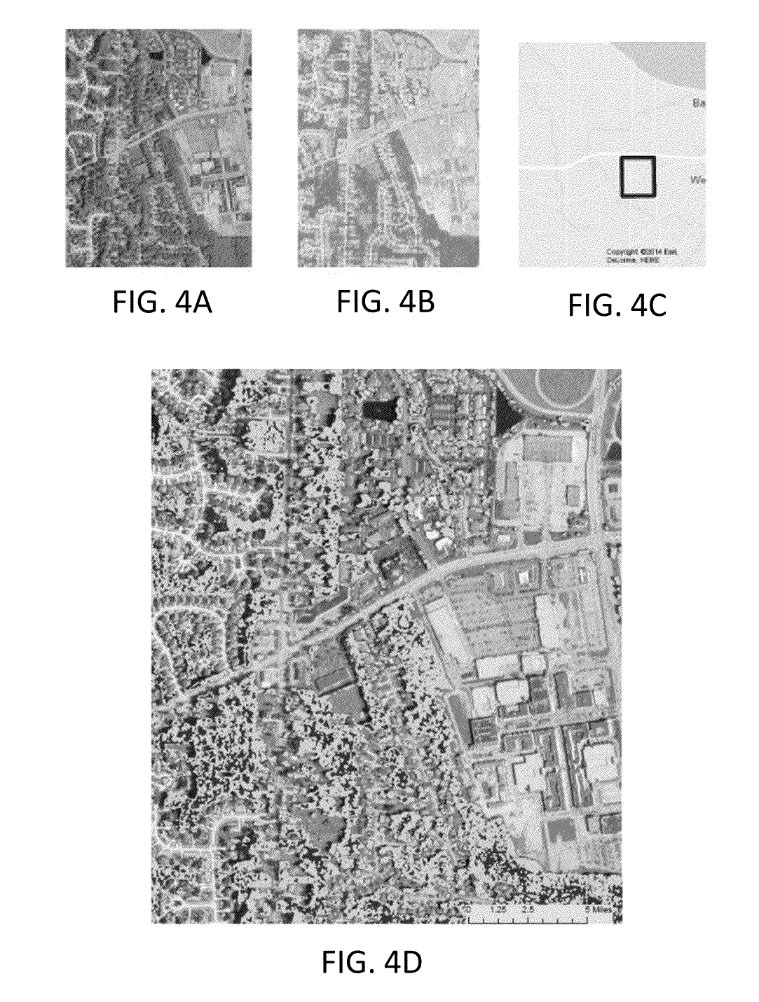

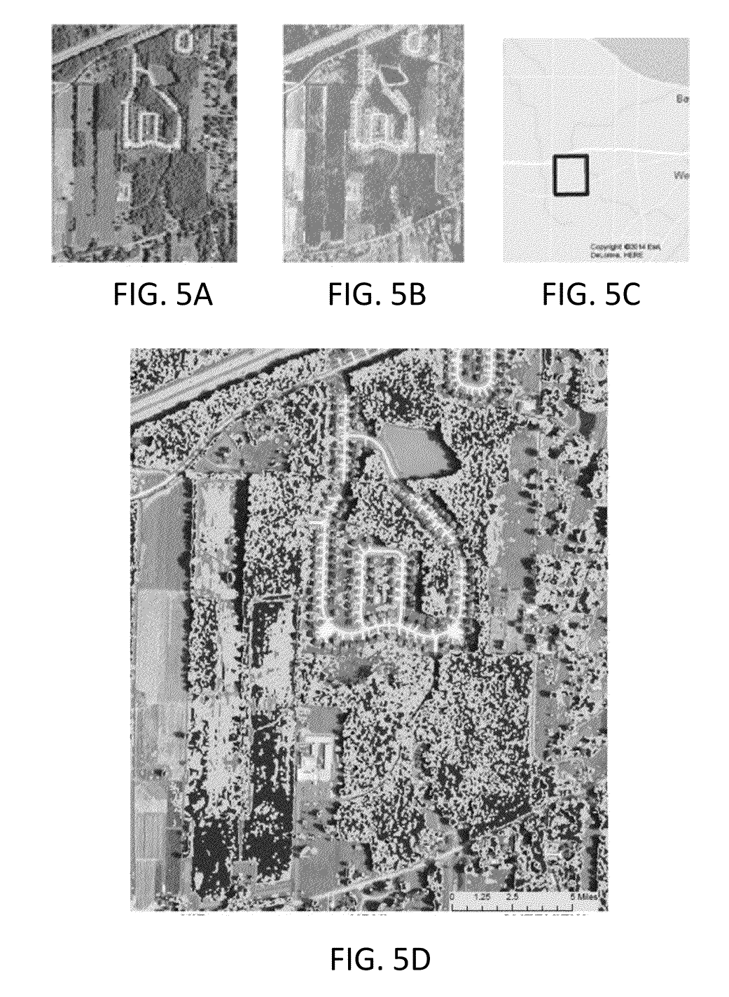

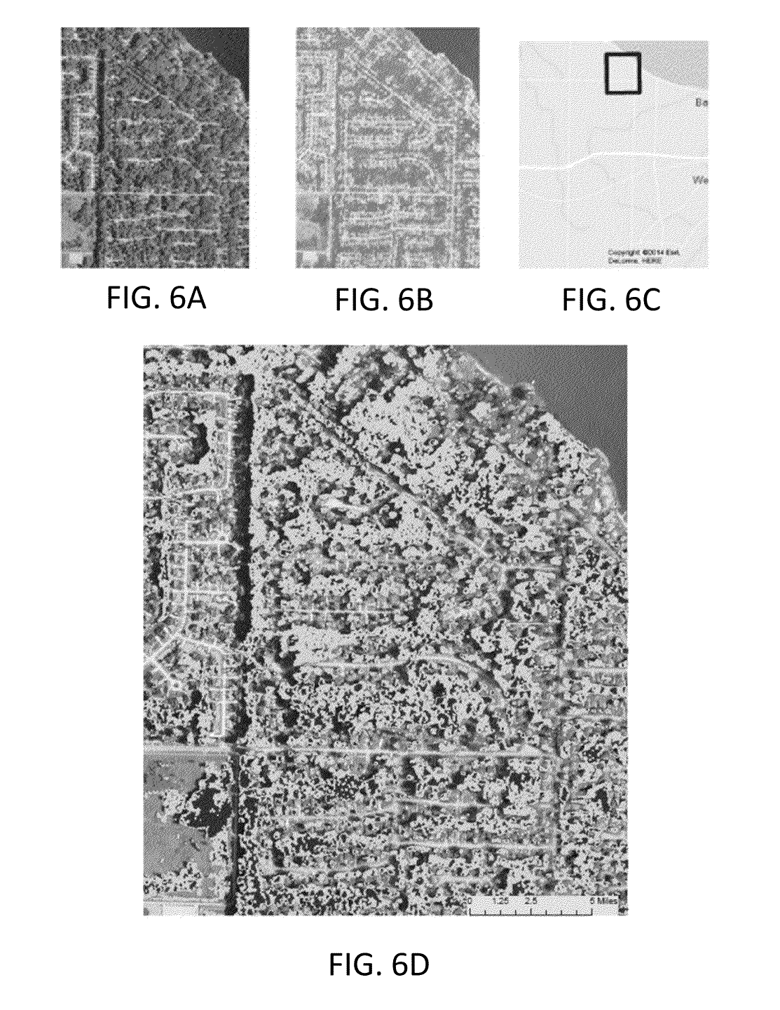

Aerial imagery from NAIP was used to identify trees for a residential and commercial area, a rural area, and a suburban area near a water body. FIGS. 4A, 5A, 6A represent infrared imagery, FIGS. 4B, 5B, 6B represent NDVI imagery, FIGS. 4C, 5C, and 6C represent an overview, and FIGS. 4D, 5D, and 6D represent an image showing tree identification (where darker shading represents taller trees), for a residential and commercial area, a rural area, and a suburban area near a water body, respectively. The images show visual examples of how one can take the NAIP image and identify trees in different areas with the methods of the disclosure.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. While embodiments are described in terms of “comprising,” “containing,” or “including” various components or steps, the embodiments can also “consist essentially of” or “consist of” the various components and steps. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A computer-implemented method of estimating the insurance risk for wind damage for a plurality of structures comprising:
calculating a Tree Proximity Score for one or more sets of geospatial coordinates from insurance loss data and tree characteristic information using a computer processor to perform the calculating;
wherein the tree characteristic information is tree characteristic information from a geographic area encompassing each of the sets of geospatial coordinates; and
wherein the sets of geospatial coordinates comprise geographic locations of a plurality of structures.

2. The method of claim 1, wherein the insurance loss data is wind loss data and the Tree Proximity Score positively correlates with wind loss data for the plurality of structures.

3. The method of claim 1, wherein the tree characteristic information is a vegetation density value for an area encompassing the set of geospatial coordinates.

4. The method of claim 3, wherein the insurance loss data scales or curves the vegetation density values.

5. The method of claim 1, wherein the insurance loss data determines a radius for the area encompassing each of the sets of geospatial coordinates.

6. The method of claim 4, wherein the insurance loss data determines curving or scaling of the vegetation density values according to geographic area.

7. The method of claim 2, wherein the correlation coefficient between Tree Proximity Score and wind loss data exceeds 0.95.

8. The method of claim 2, wherein the wind loss data is wind loss frequency.

9. The method of claim 2, wherein the wind loss data is wind loss ratio.

10. The method of claim 6, wherein the geographic area is selected from the group consisting of street, tax parcel, subdivision, neighborhood or development, zip5, city, county, zip3, Metropolitan Statistical Area (MSA), and state.

11. The method of claim 3, wherein the vegetation density value is the Normalized Difference Vegetation Index (NDVI).

12. The method of claim 3, wherein the vegetation density value is selected from the group consisting of the Perpendicular Vegetation Index, the Soil-Adjusted Vegetation Index, the Atmospherically Resistant Vegetation Index, the Global Environment Monitoring Index, and the Fraction of Absorbed Photosynthetically Active Radiation.

13. The method of claim 1, wherein the tree characteristic information is selected from one or more of tree geometric dimensions, tree height, or tree species.

14. The method of claim 1, wherein the tree characteristic information is a combination of two or more of a vegetation density value, tree geometric dimensions, tree height, and tree species.

15. The method of claim 1, wherein the tree characteristic information is derived from raw tree sensor data selected from the group consisting of satellite imagery, aerial imagery, and LiDAR.

16. A computer-implemented method of estimating the insurance risk for wind damage for a target structure, the method comprising:
receiving a query comprising an address of a target structure;
converting the address of the target structure to a set of geospatial coordinates;
querying an electronic database with the set of geospatial coordinates to identify a Tree Proximity Score associated with the set of geospatial coordinates, wherein the Tree Proximity Score is calculated from insurance loss data and tree characteristic information using a computer processor; and
displaying the Tree Proximity Score on a graphical user interface.

17. The method of claim 16, wherein the set of geospatial coordinates corresponds to a single point.

18. The method of claim 16, wherein the set of geospatial coordinates corresponds to a plurality of points representing a polygon and tree characteristic information within an area of the edges of the polygon is used to calculate the Tree Proximity Score.

19. A computer-implemented method of estimating the insurance risk for wind damage for a target structure, the method comprising:
receiving a query for an address of a target structure or a set of geospatial coordinates corresponding to geographic location of a target structure;
optionally, converting the address of the target structure to a set of geospatial coordinates corresponding to the geographic location of the target structure if an address is received;
calculating a Tree Proximity Score for the target structure using a computer processor, insurance loss data, and vegetation density values corresponding to a geographic area having a radius from the target structure, which area encompasses a plurality of structures, wherein the insurance loss data scales or curves the vegetation density values, or determines the radius from the target structure, or determines curving or scaling of the vegetation density values according to geographic area.

20. The method of claim 19, wherein the insurance loss data is wind loss data and the Tree Proximity Score positively correlates with wind loss data for the plurality of structures, the correlation having a correlation coefficient exceeding 0.90.

21. The method of claim 15, wherein the tree characteristic information is derived from a multispectral or hyperspectral image.

22. The method of claim 21, wherein the multispectral or hyperspectral image captures image data at a red spectral band and a near-infrared spectral band, and the tree characteristic information is derived from the red spectral band and the near-infrared spectral band.
